(19) United States
(12) Patent Application Publication
(10) Pub. No.: US 2009/0067718 A1
(43) Pub. Date: Mar. 12, 2009

(54) Designation of Image Area

(75) Inventor: Kosuke SHINGAI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 12/206,535

(22) Filed: Sep. 8, 2008

(30) Foreign Application Priority Data
Sep. 11, 2007 (JP) 2007-235122

(51) Int. Cl. G06K 9/34

(52) U.S. Cl. 382/173

(57) ABSTRACT

An image processing device includes an image display unit that displays an image; an area designation receiving unit that receives designation of a first area in a display image by a user; a transformation processing unit that transforms an image corresponding to the first area in a predetermined transformation area in order to transform an image of a specific kind of photographic subject; and a reference display unit that shows a predetermined reference display in the display image in order to allow the user to designate an area, which includes a second area corresponding to the transformation area in the display image, as the first area.

### CROSS-REFERENCE TO RELATED APPLICATIONS

This application claims the benefit of priority under 35 USC 119 of Japanese patent application no. 2007-235122, filed on Sep. 11, 2007, which is incorporated herein by reference.

### BACKGROUND

1. Technical Field

The invention relates to a technique for designating an area of an image.

2. Related Art

An image processing technique that transforms an image is known (for example, JP-A-2004-318204). JP-A-2004-318204 discloses an image processing technique capable of transforming a facial image by setting an area of the facial image (which shows a cheek image) in part as a correction area, dividing the correction area into plural small areas in accordance with a predetermined pattern, and enlarging or reducing the image at a ratio set in each of the small areas.

Meanwhile, a process (a so-called trimming process) of designating an area of an image in part and trimming away an area other than the designated area or a process of enlarging only the designated area to display or print the designated area has been widely used.

When the contour of the facial image described above is corrected, an area around the facial image as well as the facial image is used in some cases in order to obtain a natural processing result. Therefore, upon performing a process of transforming the contour of the facial image in an image corresponding to the designated area of the image, the transforming process cannot be performed when the area around the facial image is not included in the designated area.

Such a problem does not only occur in a process of transforming the facial image, but also occurs commonly in a process of designating an area of an image and transforming an image of a specific kind of a photographic subject corresponding to the designated area.

### SUMMARY

An advantage of some aspects of the invention is that it provides a technique for designating an area of an image without difficulty in transforming an image of a specific kind of a photographic subject.

According to an aspect of the invention, an image processing device includes: an image display unit that displays an image; an area designation receiving unit that receives designation of a first area in a display image by a user; a transformation processing unit that transforms an image corresponding to the first area in a predetermined transformation area in order to transform an image of a specific kind of photographic subject; and a reference display unit that shows a predetermined reference display in the display image in order to allow the user to designate an area, which includes a second area corresponding to the transformation area in the display image, as the first area.

In the image processing device, the area including the second area in the display image corresponding to the transformation area to be subjected to the process of transforming an image of the specific kind of photographic subject can be designated as the first area, since the predetermined reference display is shown in the display image. Accordingly, in the image processing device, it is possible to designate the image area without difficulty in transforming the image of the specific kind of photographic subject.

In the image process device having the above-described configuration, the reference display may include a display showing a third area having a relationship with the first area that is set in advance so that the first area includes the second area, when the third area is set so as to include the image of the specific kind of photographic subject.

According to the image processing device, the first area is an area including the second area when the user designates the first area so that the third area includes the image of the specific kind of photographic subject with reference to the display showing the third area. Accordingly, in the image processing device, it is possible to designate the image area without difficulty in transforming the image of the specific kind of photographic subject.

In the image process device having the above-described configuration, the reference display may include a display showing the second area.

According to the image processing device, the user can designate the first area with reference to the display showing the second area so that the first area includes the second area. Therefore, according to the image processing device, it is possible to designate the image area without difficulty in transforming the image of the specific kind of photographic subject.

The image process device having the above-described configuration may further include a photographic subject area setting unit that sets an area of the image of the specific kind of photographic subject. The reference display may include a display showing a fourth area corresponding to the set area of the image of the specific kind of photographic subject and a display showing a fifth area having a relationship with the first area that is set in advance so that the first area includes the second area, when the fifth area is set so as to include the fourth area.

According to the image processing device, the first area is the area including the second area when the user designate the first area with reference to the display showing the fifth area so that the fifth area includes the fourth area. Therefore, according to the image processing device, it is possible to designate the image area without difficulty in transforming the image of the specific kind of photographic subject.

In the image process device having the above-described configuration, the transformation area may have a predetermined relationship with the image of the specific kind of photographic subject in terms of a location and a size.

According to the image processing device, it is possible to designate the image area without difficulty in transforming the image of the specific kind of photographic subject, when the transformation area having the predetermined relationship with the image of the specific kind of photographic subject in terms of a location and a size is transformed.

In the image process device having the above-described configuration, the specific kind of photographic subject may be a face of a person.

According to the image processing device, it is possible to designate the image area without difficulty in transforming the facial image of a person.

The invention can be realized in various forms. For example, the invention can be realized in an image processing method and an image processing devices an image correcting method and an image correcting device, an image display method and an image display device, an image area designating method and an image area designating device, a printing method and a printing device, a computer program that executes functions of the devices and methods, a recording medium that records the computer program, a data signal including the computer program that is realized in the form of carrier waves, and the like.

### BRIEF DESCRIPTION OF THE DRAWINGS

The invention is described with reference to the accompanying drawings, wherein like numbers reference like elements.

FIG. 1 is a schematic explanatory diagram of a printer as an image processing device according to an embodiment of the invention.

FIG. 2 is a flowchart of a printing process in a natural face mode.

FIG. 3 is an explanatory diagram illustrating an example of a user interface used to set a target image TI.

FIG. 4 is an explanatory diagram illustrating an example of a set result of a facial area FA.

FIG. 5 is a flowchart illustrating a sequence of setting a correction degree.

FIG. 6 is an explanatory diagram illustrating an example of a user interface used to select a correction degree setting method.

FIG. 7 is an explanatory diagram illustrating an example of the user interface used to select and set the correction degree in accordance with a manual setting method.

FIG. 8 is an explanatory diagram illustrating an example of a display screen of the target image TI and the correction degree.

FIG. 9 is an explanatory diagram illustrating an example of a face sheet FS.

FIG. 10 is an explanatory diagram illustrating an example of a user interface used to set printing areas for the face sheet FS.

FIG. 11 is an explanatory diagram showing a relationship between a trimming frame TF and a reference frame RF.

FIG. 12 is an explanatory diagram illustrating an example of the determined trimming frame TF.

FIG. 13 is an explanatory diagram illustrating an example of a guide display.

FIG. 14 is an explanatory diagram illustrating an example of a user interface used to set a correction degree using the face sheet FS.

FIG. 15 is an explanatory diagram illustrating an example of displaying the target image TI and a selected image number.

FIG. 16 is an explanatory diagram illustrating an example of a user interface used to set the printing area.

FIG. 17 is a flowchart illustrating a facial contour correcting sequence carried out in the printer according to this embodiment.

FIG. 18 is an explanatory diagram illustrating an example of a method of setting a transformation area TA.

FIG. 19 is an explanatory diagram illustrating an example of a method of dividing the transformation area TA into small areas.

FIG. 20 is an explanatory diagram illustrating an example of the contents of a division point movement table.

FIG. 21 is an explanatory diagram illustrating an example of moving locations of the division points D with reference to the division point movement table.

FIG. 22 is an explanatory diagram showing a concept of an image transforming method performed by a division area transforming portion.

FIG. 23 is an explanatory diagram showing a concept of the image transforming method performed in a triangular area.

FIG. 24 is an explanatory diagram showing facial contour correcting according to this embodiment.

FIG. 25 is an explanatory illustrating an example of a user interface used to set the printing area for face sheet FS in Modified Example 1.

FIG. 26 is an explanatory illustrating an example of a user interface used to set the printing area for face sheet FS in Modified Example 2.

### DESCRIPTION OF EXEMPLARY EMBODIMENTS

Hereinafter, an embodiment of the invention is described in the following order:
A. Embodiment
A-1. Configuration of Image Processing Device,
A-2. Printing Process,
A-3. Facial Contour Correcting Process, and
B. Modified Examples.

### A. Embodiment

### A-1. Configuration of Image Processing Device

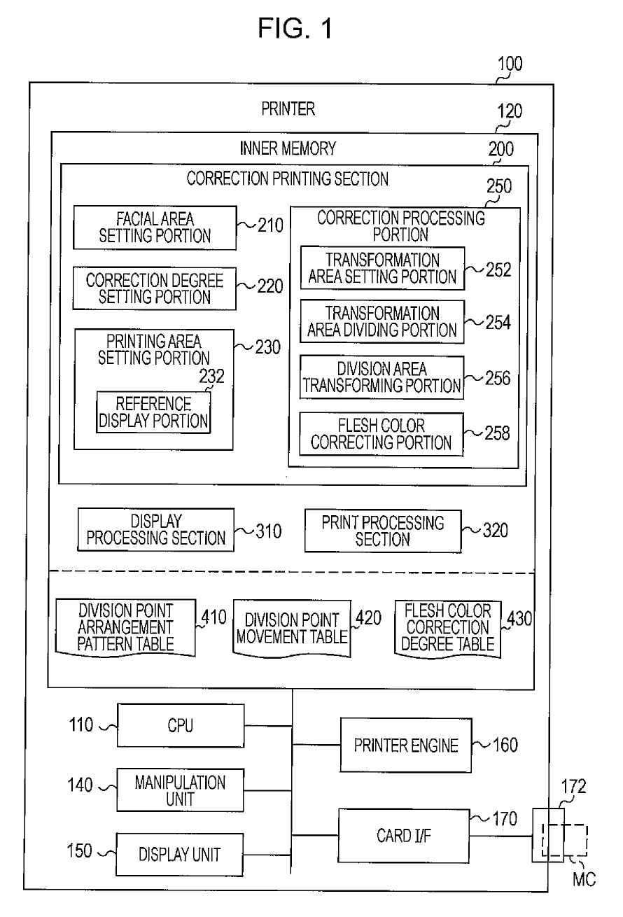

FIG. 1 is a schematic explanatory diagram of a printer 100 as an image processing device according to an embodiment of the invention. According to the embodiment, the printer 100 is a color inkjet printer corresponding to a so-called direct printer that prints an image on the basis of image data acquired from a memory card MC or the like. The printer 100 includes a CPU 110 that controls units of the printer 100, an inner memory 120 that includes a ROM, a RAM, and the like, a manipulation unit 140 that includes buttons or a touch panel, a display unit 150 that includes a liquid crystal display, a printer engine 160, and a card interface (card I/F) 170. The printer 100 may further include an interface that performs data communication with another device (for example, a digital still camera or a personal computer). The constituent elements of the printer 100 are connected to each other through buses.

The printer engine 160 is a printing mechanism that performs printing on the basis of printing data. The card interface 170 exchanges data with a memory card MC inserted into a card slot 172. In this embodiment, an image file containing image data as RGB data is stored in the memory card MC. The image file is generated on the basis of the Exif (Exchangeable Image File Format) standard by an image pick-up device such as a digital still camera and contains appended data on an iris, a shutter speed, a focal distance of a lens, or the like of an image pick-up process, in addition to image data having a JPEG format that is generated by the image pick-up process.

A correction printing section 200, a display processing section 310, and a print processing section 320 are stored in the inner memory 120. The correction printing section 200 is a computer program that executes a printing process in a natural face mode described below under an environment of a predetermined operation system. The display processing section 310 is a display driver that controls the display unit 150 to display process menus, messages, images, and the like on the display unit 150. The print processing section 320 is a computer program that generates the printing data from the image data, controls the printer engine 160, and performs printing of an image on the printing data. The CPU 110 executes functions of the constituent elements by loading programs from the inner memory 120 and executing the programs.

The correction printing section 200 is a program module that includes a facial area setting portion 210, a correction degree setting portion 220, a printing area setting portion 230, and a correction processing portion 250. The printing area setting portion 230 includes a reference display portion 232. The correction processing portion 250 includes a transformed-area setting portion 252, a transformed-area dividing portion 254, a division area transforming portion 256, and a flesh color correcting portion 258. Functions of these constituent elements are described in detail below.

A division point arrangement pattern table 410, a division point movement table 420, and a flesh color correction degree table 430 are stored in the inner memory 120. These elements are also described in detail below.

### A-2. Printing Process

The printer 100 can perform the printing process in a natural face mode in which a facial image part of an image is corrected and the corrected image is printed. In the natural face mode, correcting a face to be reduced (“face reduction correcting process) and correcting a skin to be clarified (“skin clarification correcting process) can be performed as the correcting process on the facial image part. The face reduction correcting process corrects a facial image part so that a facial image likely to have an impression that the width of the facial image is broader than that of an actual face is closer to the actual face. The skin clarification correcting process corrects a color of an image of a facial skin color part so that a facial skin color likely to have an impression that the facial skin color is different from an actual skin color is closer to the actual skin color.

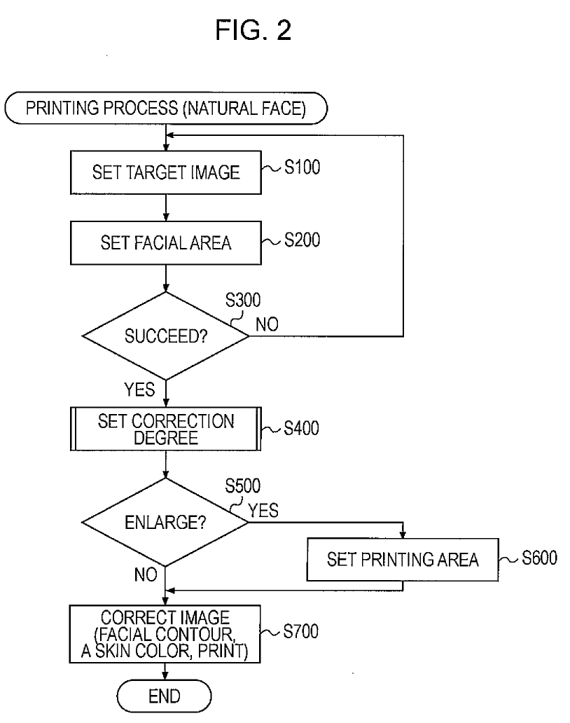

FIG. 2 illustrates a sequence of a printing process in the natural face mode. The printing process in the natural face mode starts when the memory card MC is inserted into the card slot 172 (see FIG. 1) and a user manipulates the manipulation unit 140.

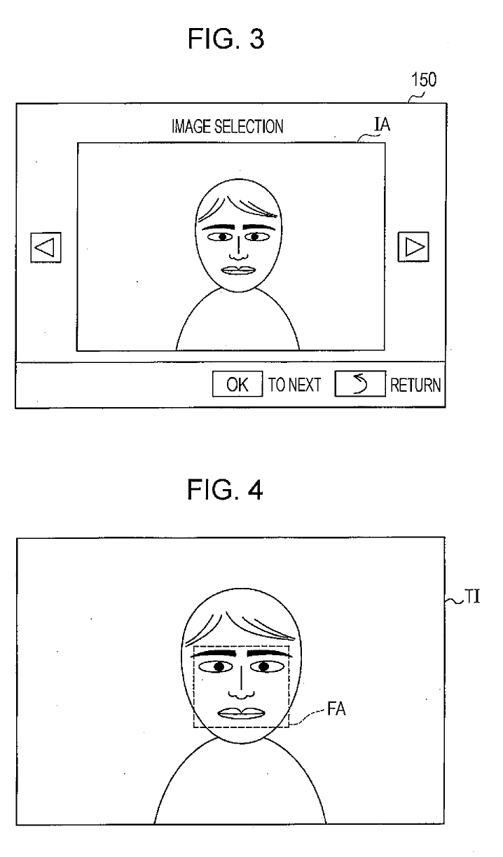

In Step S100 (FIG. 2), the correction print section 200 (FIG. 1) sets a target image TI to be printed. The correction print section 200 instructs the display processing section 310 to display a predetermined user interface used to set the target image TI on the display unit 150. FIG. 3 shows an example of the user interface used to set the target image TI. An image stored in the memory card MC is displayed on an image display area IA of the user interface shown in FIG. 3. When a plurality of images are stored in the memory card MC, the images displayed on the image display area IA are shown one by one in accordance with manipulation of a user through the manipulation unit 140. The printer 100 may display a list of the plurality of images stored in the memory card MC. The correction print section 200 sets an image selected by a user as the target image TI in the user interface of FIG. 3.

In Step S200 (FIG. 2), the facial area setting portion 210 (FIG. 1) sets a facial area FA in the target image TI. The facial area FA is an image area in the target image TI and an area containing a part of a facial image. The facial area setting portion 210 detects an area supposed to contain the facial image by analyzing the target image TI and sets the area as the facial area FA. The detecting of the area supposed to contain the facial image performed by the facial area setting portion 210 is performed using a known detecting method such as a pattern matching method (see JP-A-2006-279460) using a template, for example. A pattern matching method using a template detects an area supposed to contain the facial image from the target image TI on the basis of locations of images of facial organs (for example, eyes, eyebrows, a noise, and a mount).

FIG. 4 illustrates an example of a set result of the facial area FA. In this embodiment, the facial area FA is set to a rectangular image that contains two eyes, a noise, and a mouth. The facial area setting portion 210 designates the set facial area FA using four vertexes of the set facial area FA, for example.

In Step S200 (FIG. 2), in a case where the area supposed to contain the facial image is not detected and the setting of the facial area FA does not succeed (No in Step S300), the fact that the setting of the facial area FA does not succeed is notified to the user through the display unit 150. Then, since the printing process cannot be performed in the natural face mode in which the facial image correcting process is performed, the user interface (see FIG. 3) that prompts the user to select the target image TI is displayed again on the display unit 150 in order to allow the user to select another image as the target image TI (Step S100).

Alternatively, in Step S200 (FIG. 2), in a case where the area supposed to contain the facial image has been detected and the setting of the facial area FA has succeeded (Yes in Step S300), the printing process can be performed in the natural face mode. In Step S400, the correction degree setting portion 220 (FIG. 1) sets a correction degree. At this time, the correction degree refers to a degree by which the correcting processes (the face reduction and skin clarification correcting processes) are performed on an image in the natural face mode.

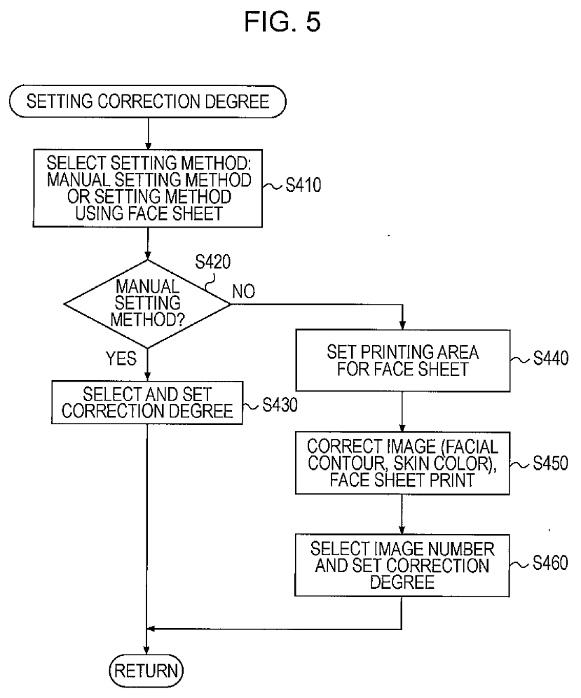

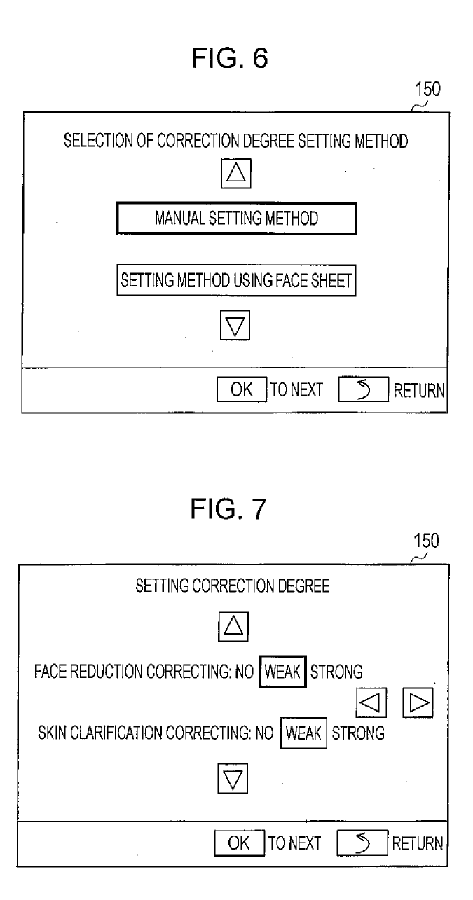

FIG. 5 illustrates a sequence of setting the correction degree. In Step S410, the correction degree setting portion 220 selects a correction degree setting method. The correction degree setting portion 220 instructs the display processing section 310 to display a predetermined user interface used to select the correction degree setting method on the display unit 150. FIG. 6 illustrates an example of the user interface used to select the correction degree setting method. In this embodiment, a manual setting method and a setting method using a face sheet FS are used as the correction degree setting method. The manual setting method employs a correction degree that is designated directly by a user in the face reduction and skin clarification correcting processes. The setting method using the face sheet FS employs a correction degree that corresponds to one image selected by a user from plural images printed on one face sheet FS that have been subjected to a correcting process by changing the correction degree in the face reduction and skin clarification correcting processes. The correction degree setting portion 220 selects a correction degree setting method in accordance with the selection by a user in a user interface of FIG. 6.

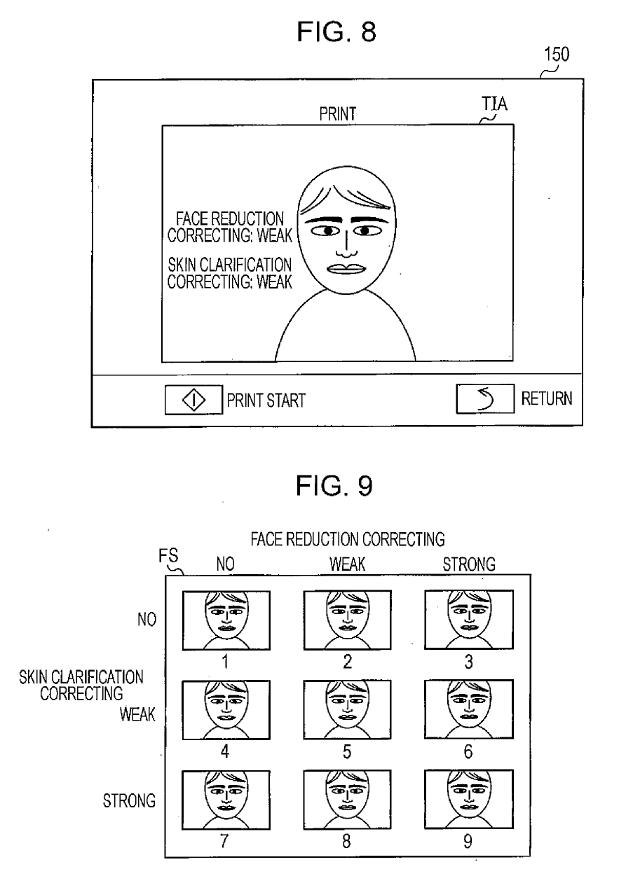

In Step S410 of FIG. 5, when the manual setting method is selected (Yes in Step S420), the correction degree setting portion 220 selects and sets the correction degree in accordance with the manual setting method (Step S430). The correction degree setting portion 220 instructs the display processing section 310 to display a predetermined user interface used to select and set the correction degree in accordance with the manual setting method on the display unit 150. FIG. 7 illustrates an example of the user interface used to select and set the correction degree in accordance with the manual setting method. In this embodiment, three selection items of “no” (no correction), “weak”, and “strong” are set in advance as the correction degrees in the face reduction and skin clarification correcting processes. The correction degree setting portion 220 sets the correction degrees for the face reduction and skin clarification correcting processes in accordance with the user selection in the user interface of FIG. 7. The correction degree setting portion 220 then instructs the display processing section 310 to display the set correction degrees and the target image TI on the display unit 150. FIG. 8 illustrates an example of a display screen of the target image TI and the correction degree. In FIG. 8, the target image TI and the correction degrees for the face reduction and skin clarification correcting processes are displayed on a target image display area TIA.

Alternatively, in Step S410 of FIG. 5, when the setting method using the face sheet FS is selected (No in Step S420), the correction degree using the face sheet FS is selected and set. FIG. 9 illustrates an example of a face sheet FS. As shown in FIG. 9, nine images corresponding to a combination of the three correction degrees (“no”, “weak”, and “strong”) for the face reduction correcting process and the three correction degrees (“no”, “weak”, and “strong”) for the skin clarification correcting process are printed on the face sheet FS. Numbers are given to the images on the face sheet FS. For example, the first image on the face sheet FS of FIG. 9 is not subjected to either of the face reduction or skin clarification correcting processes. The fifth image is subjected to the “weak” face reduction correcting process and the “weak” skin clarification correcting process.

In Step S440 (FIG. 5), the printing area setting portion 230 (FIG. 1) first sets a printing area for the face sheet FS in the target image TI (Step S440). In this embodiment, in order to easily compare the images on the face sheet FS, the printing areas for the face sheet FS are set so that the facial images are printed as large as possible. Acquiring, correcting, and printing a face sheet image FI described below are performed on the set printing area for the face sheet FS. In this case, the set printing areas define areas where images will be printed on the face sheet FS, but do not define printing areas in a final image printing process (Step S700 of FIG. 2).

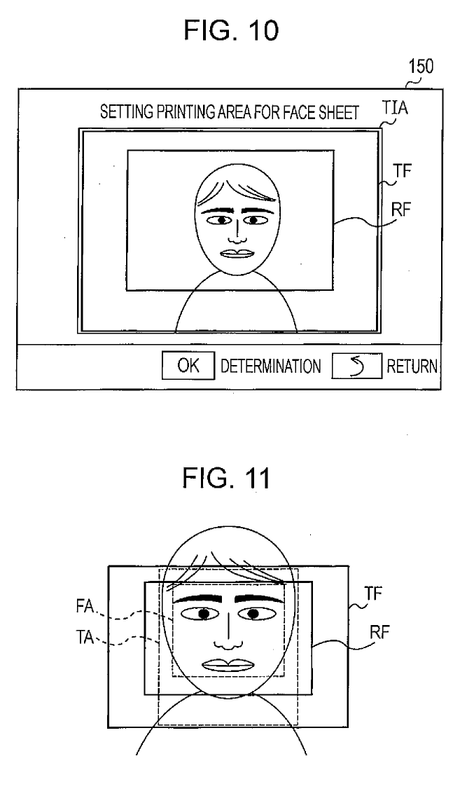

The printing area setting portion 230 instructs the display processing section 310 to display a predetermined user interface used to set the printing areas for the face sheet FS on the display unit 150. FIG. 10 illustrates an example of the user interface used to set the printing areas for the face sheet FS. In FIG. 10, the target image TI is displayed in the target image display area TIA. More specifically, an image displayed in the target image display area TIA is an image (“display image DI”) formed by decoding image data having the JPEC format included in an image file stored in the memory card MC, and reducing (or enlarging) the decoded image data in accordance with a resolution of the target image display area TIA displayed on the display unit 150.

In the user interface of FIG. 10, a trimming frame TF is displayed on the display image DI. The trimming frame TF defines an area corresponding to the printing areas for the face sheet FS on the display image DI. The trimming frame TF can be enlarged, reduced, moved, and rotated in accordance with manipulation of the user through the manipulation unit 140. Moreover, the target image TI corresponding to the trimming frame TF finally determined by the user is set as the printing area for the face sheet FS.

In the user interface of FIG. 10, a reference frame RF is displayed on the display image DI. The reference frame RF is displayed in such a manner that the reference display portion 232 (FIG. 1) instructs the display processing section 310. The reference frame RF is set in advance to have a predetermined relationship to the trimming frame TF in terms of location and size. Moreover, the reference frame RF is enlarged, reduced, moved, and rotated with the enlargement, reduction, movement, and rotation of the trimming frame TF while maintaining the predetermined relationship.

The relationship between the trimming frame TF and the reference frame RF is now described. FIG. 11 shows the relationship between the trimming frame TF and the reference frame RF. In FIG. 11, the facial area FA and a transformation area TA to be transformed in the face reduction correcting process are shown. The transformation area TA, which is described in detail below, is an area where the facial area FA is enlarged at a predetermined ratio rightward and leftward. The transformation area TA is set to also include a peripheral image of a face in addition to a facial image.

The transformation area will be subjected to transformation in the face reduction correcting process. Therefore, the face reduction correcting process cannot be performed if the printing area for the face sheet FS is set to not include a part or all of the transformation area TA. Therefore, it is necessary to set the printing area for the face sheet FS as an area including the transformation area TA. That is, on the display image DI, as shown in FIG. 11, it is required that the trimming frame TF be set to include an area corresponding to the transformation area TA therein.

The relationship between the trimming frame TF and the reference frame RF in terms of location and size is set in advance so that the trimming frame TF includes an area on the display image DI corresponding to the transformation area TA therein when the reference frame RF is set to substantially include the facial image therein. Accordingly, the printing area for the face sheet FS that is set as the area on the target image TI corresponding to the trimming frame TF becomes an area including the transformation area TA, when the user designates the trimming frame TE substantially including the facial image inside the reference frame RF.

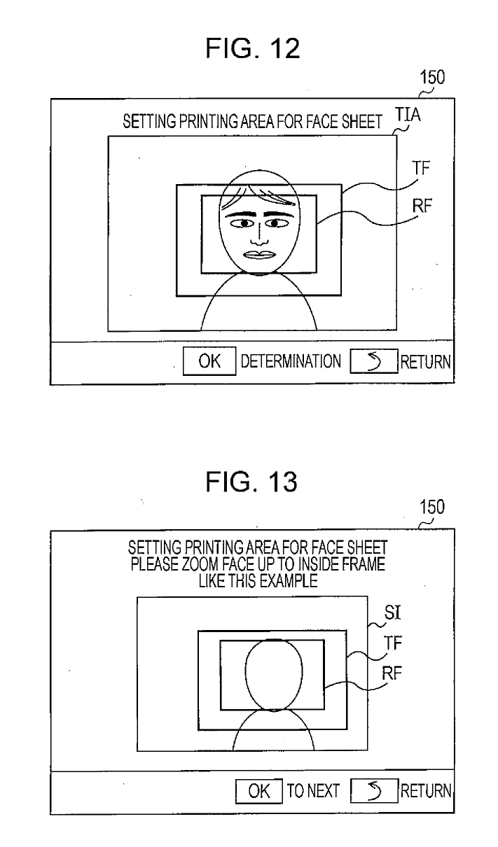

The user determines the location or size of the trimming frame TF to substantially include the facial image inside the reference frame RF by enlarging, reducing, moving, and rotating the trimming frame TF with reference to the reference frame RF. FIG. 12 illustrates an example of the determined trimming frame TF. The printing area setting portion 230 sets the area on the target image TI corresponding to the determined trimming frame TF as the printing area for the face sheet FS.

An area inside the trimming frame TF on the display image DI corresponds to a first area in the invention and an area corresponding to the transformation area TA on the display image DI corresponds to a second area in the invention. The reference frame RF corresponds to a reference display in the invention and an area inside the reference frame RF corresponds to a third area in the invention. In addition, the printing area setting portion 230 receiving a command for determination of the trimming frame TF functions as an area designation receiving unit in the invention.

Upon determining the trimming frame TF described above, a predetermined guide display for a user may be shown. FIG. 13 illustrates an example of the guide display. In the guide display, as shown in FIG. 13, a sample image SI including the facial image is displayed and the trimming frame TF and the reference frame RF are displayed on the sample image SI. At this time, the location and size of the reference frame RF is configured so that the reference frame RF substantially includes the facial image included in the sample image SI inside the reference frame RF. In this way, by showing the guide display, it is possible to prompt the user to designate the trimming frame TF in which the printing area for the face sheet FS substantially includes the transformation area TA.

In Step S450 (FIG. 5), the correction print section 200 (FIG. 1) performs an image correcting process on an image of the printing area for the set face sheet FS (“face sheet image FI”), and performs printing of an image subjected to the correcting process on the face sheet FS. The correction processing portion 250 performs the face reduction and skin clarification correcting processes on the face sheet image FI. At this time, the correction processing portion 250 performs the correcting processes and generates nine corrected images by performing the nine correcting process corresponding to combinations of the three correction degrees (“no”, “weak”, and “strong”) for the face reduction correcting process and the three correction degrees (“no”, “weak”, and “strong”) for the skin clarification correcting process. The correcting processing portion 250 corresponds to a transformation processing unit in the invention.

The skin clarification correcting process is performed by setting a flesh color area in the face sheet image FI and adjusting a color of the set flesh color area by a correction degree defined in accordance with a correction degree in the flesh color correction degree table 430 (FIG. 1). The face reduction correcting process is performed by dividing the transformation area TA (FIG. 11) in the face sheet image FI into plural areas and transforming shapes of the divided areas by a transformation degree defined in accordance with the correction degree in the division point movement table 420 (FIG. 1). The face reduction correcting process (“facial contour correcting process”) is described in detail in “A-3. Facial Contour Correcting Process” below.

The correction print section 200 instructs the print processing section 320 (FIG. 1) to print the face sheet FS (FIG. 9) of the nine corrected images generated by the correcting process on the face sheet image FI. In this way, the images on the face sheet FS are printed.

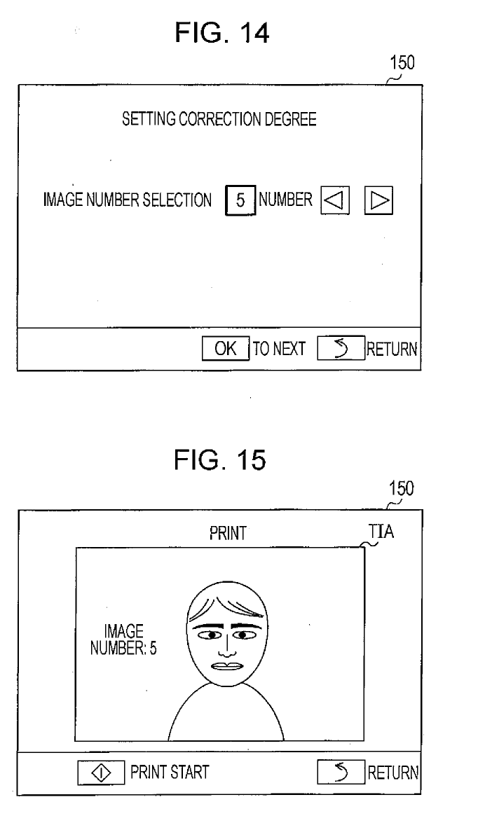

In Step S460 (FIG. 5), the correction degree setting portion 220 sets the correction degree by selecting the image number on the face sheet FS. The correction degree setting portion 220 instructs the display processing section 310 to display a predetermined user interface used to set the correction degree using the face sheet FS on the display unit 150. FIG. 14 illustrates an example of the user interface used to set the correction degree using the face sheet FS. The user interface includes an image number selection area on the face sheet FS. The user selects an image that is the closest to a desired correction result among the nine images (FIG. 9) on the face sheet FS and inputs the image number in the user interface of FIG. 14. The correction degree setting portion 220 sets the correction degree corresponding to the image selected by the user as a correction degree to be used. For example, when the user selects the fifth image, the correction degrees of “weak” for the face reduction and skin clarification correcting processes are set as the correction degrees corresponding to the fifth image. The correction degree setting portion 220 then instructs the display processing section 310 to display the selected image number and the target image TI on the display unit 150. FIG. 15 illustrates an example of displaying the target image TI and the selected image number. In FIG. 15, the target image TI and the selected image number are displayed in the target image display area TIA.

In this way, the setting of the correction degree (Step S400 of FIG. 2) is performed. Next, the correction print section 200 (FIG. 1) determines whether the user instructs enlargement printing through the manipulation unit 140 (Step S500). Enlargement printing means that a partial area of the target image TI is enlarged and printed.

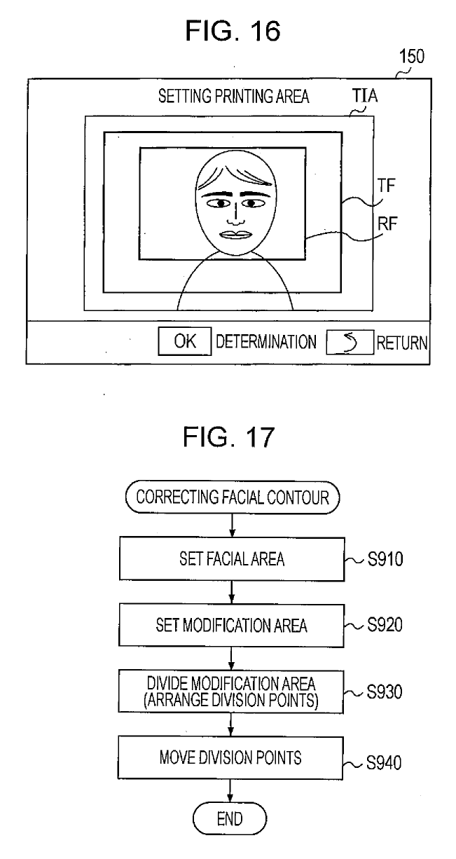

When enlargement printing is instructed (Yes in Step S500), the printing area setting portion 230 (FIG. 1) sets the printing area (Step S600). The printing area is set in the same manner as the setting (Step S440 of FIG. 5) of the printing area for the face sheet FS. That is, the printing area setting portion 230 instructs the display processing section 310 to display a predetermined user interface used to set the printing area on the display unit 150. FIG. 16 illustrates an example of the user interface used to set the printing area. In FIG. 16, the display image DI is displayed in the target image display area TIA and the trimming frame TF and the reference frame RF are displayed in the display image DI as in the user interface (FIG. 10) used to set the printing area for the face sheet FS. The user determines the location and size of the trimming frame TF within a range substantially including the facial image inside the reference frame RF with reference to the reference frame RF. The printing area setting portion 230 sets an area in the target image TI corresponding to the determined trimming frame TF as the printing area. In this way, when the printing area is set, the printing area set as the area in the target image TI corresponding to the trimming frame TF includes the transformed area TA.

Alternatively, when the enlargement printing is not instructed (No in Step S500), the whole target image TI becomes the printing area naturally.

In Step S700 (FIG. 2), the correction print section 200 (FIG. 1) performs an image correcting process on an image of the printing area (“printing image PI”) and prints the image subjected to the correcting process. At this time, the correcting processes (the face reduction and skin clarification correcting processes) are performed by the correction processing portion 250 by the correction degree set in Step S400. In this way, the image subjected to the face reduction and skin clarification correcting processes is printed. Moreover, the correction processing portion 250 functions as a modification processing unit in the invention.

In the printer 100 according to this embodiment, as described above, the trimming frame TF and the reference frame RF are displayed in the display image DI when the printing area for the face sheet FS is set (Step S440 of FIG. 5). The relationship between the trimming frame TF and the reference frame RF is set so that the trimming frame TF includes the area in the display image DI corresponding to the transformation area TA therein when the reference frame RF is set to substantially include the facial image therein. Therefore, the printing area for the face sheet FS set as the area in the target image TI corresponding to the trimming frame TF becomes the area including the transformation area TA, when the user designates the trimming frame TF substantially including the facial image inside the reference frame RF. Accordingly, the image corresponding to the printing area for the face sheet FS (face sheet image FI) becomes an image including the image area required upon performing the face reduction correcting process (Step S450 of FIG. 5). In this way, the printer 100 according to this embodiment designates an image area without difficulty in transforming a facial image.

In the printer 100 according to this embodiment, the printing image PI corresponding to the printing area also becomes the image including the image area necessary upon performing the face reduction correcting process (Step S700 of FIG. 2), since the trimming frame TF and the reference frame RF are displayed in the display image DI upon setting the printing area (Step S600 of FIG. 2).

### A-3. Facial Contour Correcting Process

FIG. 17 illustrates a facial contour correcting sequence carried out in the printer 100 according to this embodiment. A facial contour correcting process (face reduction correcting process) is one of correcting processes performed in Step S700 of FIG. 2 and Step S450 of FIG. 5 and is a process of correcting a facial contour in the printing image PI or the face sheet image FI. A case where a target image to be subjected to the facial contour correcting process is the face sheet face FI is now described.

In Step S910 (FIG. 17), the facial area setting portion 210 (FIG. 1) sets the facial area FA in the face sheet image FI. The setting of the facial area FA in Step S910 is performed in the same manner as the setting of the facial area FA in Step S200 of FIG. 2. In Step S910, the setting of the facial area FA may be performed using the setting result of the facial area FA in Step S200 without newly detecting the facial area FA.

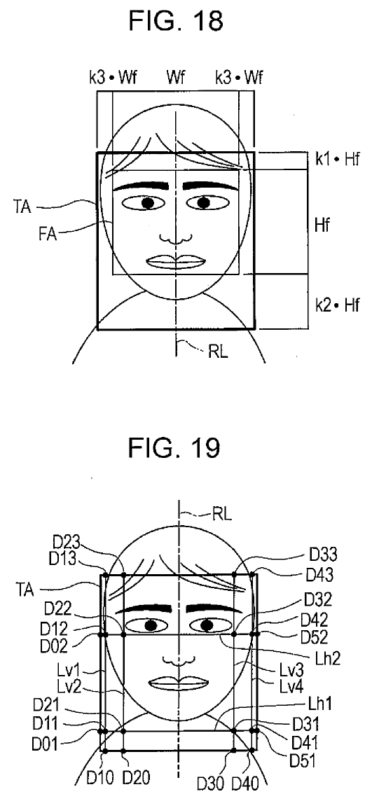

In Step S920 (FIG. 17) the transformation area setting portion 252 (FIG. 1) sets the transformation area TA in the face sheet image FI. The transformation area TA is an area to be subjected to the image transforming process of correcting the facial contour. FIG. 18 illustrates an example of a method of setting the transformation area TA. A facial image of a person and the set facial area FA are showed in FIG. 18. Reference line RL of FIG. 18 defines a height-wise direction (upward and downward directions) of the facial area FA and shows a center in a widthwise direction (right and left directions) of the facial area FA. That is, the reference line RL is a straight line that passes through the center of the rectangular facial area FA and is parallel to boundary lines in the height-wise (vertical) direction of the facial area FA.

In this embodiment, as shown in FIG. 18, the transformed area TA is set to an area where the facial area FA is enlarged (reduced) in a direction (height-wise direction) parallel to the reference line RL a direction (the widthwise direction) perpendicular to the reference line RL. Specifically, on the assumption that a size of the facial area FA in the height-wise direction is Hf and a size of the facial area FA in the widthwise direction is Wf, an area produced by enlarging the facial area FA by k1·Hf in the upward direction, by k2·Hf in the downward direction, and by k3·Wf in the right and left directions is set as the transformation area TA, where k1, k2, and k3 are predetermined coefficients.

When the transformation area TA is set in this way, the reference line RL that is the straight line parallel to the outline of the facial area FA in the height-wise direction is a straight line parallel to of the outline of the transformation area TA in the height-wise direction. Moreover, the reference line RL halves the width of the transformation area TA.

As shown in FIG. 18, the transformation area TA is set to approximately include an image from a chin to a frame in the height-wise direction and an image of right and left cheeks in the widthwise direction. That is, in this embodiment, the coefficients k1, k2, and k3 are set in advance on the basis of the relationship with the size of the facial area FA so that the transformation area TA approximately includes the images within such ranges.

In Step S930 (FIG. 17), the transformed-area dividing portion 254 (FIG. 1) divides the transformation area TA into plural small areas. FIG. 19 illustrates an example of a method of dividing the transformation area TA into the small areas. The transformed-area dividing portion 254 arranges plural division points D in the transformation area TA and divides the transformation area TA into the plural small areas using straight lines meeting the division points D.

The arrangement of the division points D (the number and location of the division points D) is defined in the division point arrangement pattern table 410 (FIG. 1). The transformed-area dividing portion 254 arranges the division points D in the transformation area TA with reference to the division point arrangement pattern tale 410.

As shown in FIG. 19, the division points D are arranged at intersection points of horizontal division lines Lh and vertical division lines Lv and at intersection points of the horizontal division lines Lh, the vertical division lines Lv, and outer frame of the transformation area TA. The horizontal and vertical division lines Lh and Lv are reference lines for arranging the division points D in the transformation area TA. As shown in FIG. 19, two horizontal division lines Lh perpendicular to the reference line RL and four vertical division lines Lv parallel to the reference line RL are set in the arrangement of the division points D. The two horizontal division lines Lh are referred to as horizontal division lines Lh1 and Lh2 sequentially from the lower side of the transformation area TA. The four vertical division lines Lv are referred to as vertical division lines Lv1, Lv2, Lv3, and Lv4 from the left side of the transformation area TA.

In the transformation area TA, the horizontal division line Lh1 is arranged below a chin image and the horizontal division line Lh2 is arranged immediately below an eyes image. The vertical division lines Lv1 and Lv4 are arranged outside the images of cheeks, and the vertical division lines Lv2 and Lv3 are arranged outside images of eyes. The horizontal and vertical division lines Lh and Lv are arranged in accordance with a correspondence relationship with the transformation area TA set in advance in terms of a size so that a relationship between the horizontal division lines Lh, the vertical division lines Lv, and the image finally satisfies the above-described relationship in terms of a location.

In accordance with the arrangement of the horizontal and vertical division lines Lh and Lv, the division points D are arranged at the intersection points of the horizontal division lines Lh and the vertical division lines Lv and at the intersection points of the horizontal division lines Lh, the vertical division lines Lv, and the outer frame of the transformation area TA. As shown in FIG. 19, the division points D located on the horizontal division lines Lhi (where i=1 or 2) are referred to as division points D0i, D1i, D2i, D3i, D4i, and D5i sequentially from the left side. For example, the division points D located on the horizontal division line Lh1 are referred to as division points D01, D11, D21, D31, D41, and D51. Likewise, the division points D located on the vertical division lines Lvj (where j=one of 1, 2, 3, 4) are referred to as the division points Dj0, Dj1, Dj2, and Dj3 sequentially from the lower side. For example, the division points D located on the horizontal division line Lv1 are referred to as division points D10, D11, D12, and D13.

As shown in FIG. 19, the arrangement of the division points D according to this embodiment is symmetric with respect to the reference line RL.

The transformed-area dividing portion 254 divides the transformation area TA into the plural small areas by the straight lines (the horizontal and vertical division lines Lh and Lv) meeting the arranged division points D. In this embodiment, as shown in FIG. 19, the transformation area TA is divided into 15 rectangular small areas.

In this embodiment, since the arrangement of the division points D depends on the number and location of the horizontal and vertical division lines Lh and Lv, it can be conversely said that the division point arrangement pattern table 410 defines the number and location of the horizontal and vertical division lines Lh and Lv.

In Step S940 (FIG. 17), the division area transforming portion 256 (FIG. 1) performs an image transforming process on the transformation area TA. The image transforming process by the division area transforming portion 256 is performed by moving the locations of the division points D arranged in the transformation area TA in Step S930 to transform the small areas.

The movement (movement direction and movement distance) of the locations of the division points D used to perform the image transforming process is determined in advance in correspondence with the correction degree in the division point movement table 420 (FIG. 1). The division area transforming portion 256 moves the locations of the division points D in the movement direction and by the movement distance corresponding to the correction degree with reference to the division point movement table 420.

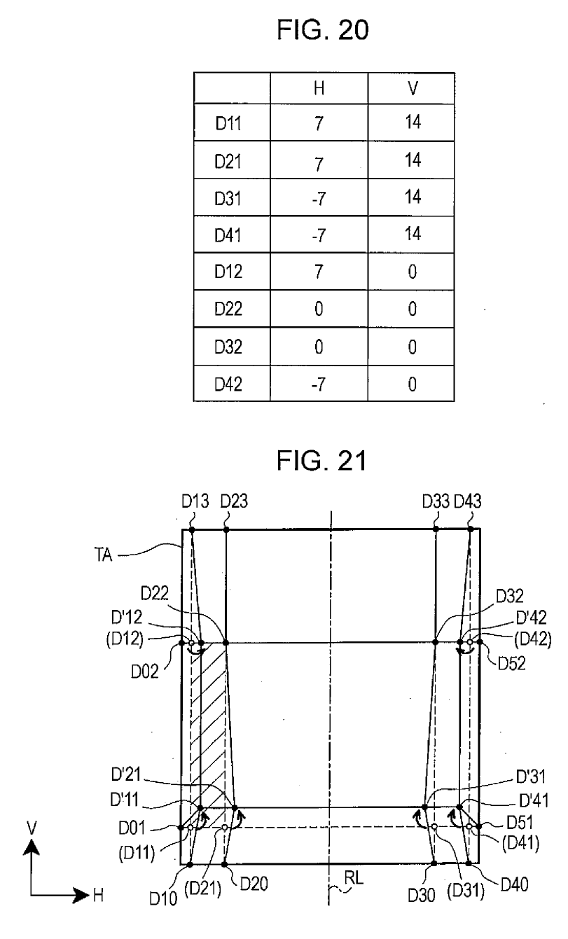

FIG. 20 illustrates an example of the division point movement table 420. FIG. 21 illustrates an example of moving the locations of the division points D with reference to the division point movement table 420. In FIG. 20, the locations of the division points D defined by the division point movement table 420 are shown in correspondence with the correction degree “weak”. As shown in FIG. 20, the division point movement table 420 shows movement distances of the division points D in a direction perpendicular to the reference line RL (H direction) and a direction parallel to the reference line RL (V direction). In this embodiment, a unit of the movement distance shown in the division point movement table 420 is a pixel pitch PP of the target image TI. For the H direction, the rightward movement distance is expressed as a positive value and the leftward movement distance is expressed as a negative value. For the V direction, the upward movement distance is expressed as a positive value and the downward movement distance is expressed as a negative value. For example, the division pint D11 is moved rightward in the H direction by 7 times as large as the pixel pitch PP and moved upward in the V direction by 14 times as large as the pixel pitch PP. The division point D22 is not moved since the movement distances in the H direction and V direction are zero.

In this embodiment, the division points D located on the outer frame of the transformation area TA (for example, division point D10, etc. of FIG. 19) are not moved lest the boundary of the image inside and outside the transformation area TA becomes unnatural. Accordingly, the movement of the division points D located on the outer frame of the transformation area TA are not defined in the division point movement table 420 of FIG. 20. The movement distance of at least one division point D corresponding to the correction degree of “strong” among the movement distances of the division points D defined in the division point movement table 420 is larger than the movement distances of FIG. 20. The movement distances of the division points D corresponding to the correction degree of “no” are defined to be zero.

In FIG. 21, the division points D that are not yet moved are expressed as a white circle, and the division points D that have been moved and division points D that are not moved are expressed as a black circle. In addition, the division points D that have been moved are referred to as division points D′. For example, the division point D11 is moved upward and rightward in FIG. 21 and becomes the division point D′11.

In this embodiment, two division points D (for example, the division points D11 and D41) having a symmetric location relationship with respect to the reference line RL maintain the symmetric location relationship with respect to the reference line RL even after the division points D are moved.

The division area transforming portion 256 performs an image transforming process so that the images of the small areas where the division points D are not yet moved become the images of the small areas newly defined after the division points D are moved in the small areas constituting the transformation area TA. In FIG. 21, for example, the image of the small area (indicated by hatching) having vertexes of the division points D11, D21, D22, and D12 is transformed into the image of the small area having the vertexes of the division points D′11, D′21, D22, and D′12.

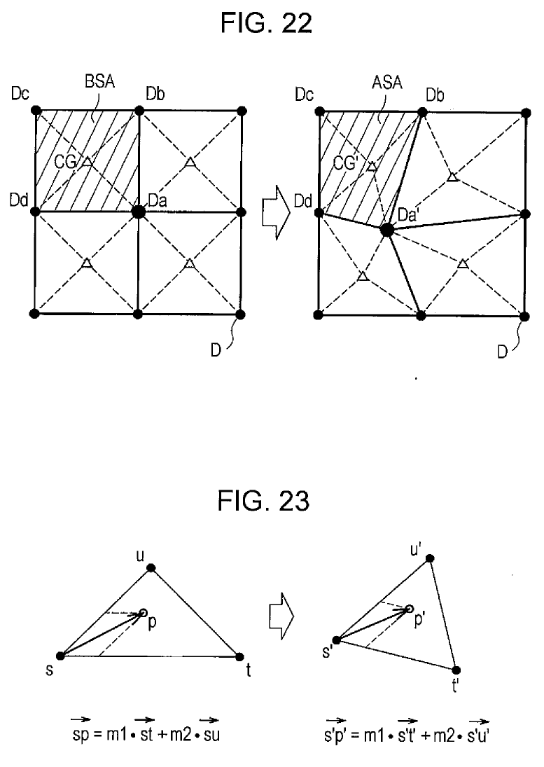

FIG. 22 shows a concept of an image transforming method performed by the division area transforming portion 256. In FIG. 22, the division points D are expressed as a black circle. In FIG. 22, for simple explanation, four small areas where the division points D are not yet moved are shown on the right side and the four small areas where the division points D have been moved are shown on the right side. In FIG. 22, a central division point Da is moved to a central division point Da′, but the other division points D are not moved. For example, an image of a rectangular small area having vertexes of division points Da, Db, Dc, and Dd before movement of the division points D (“before-transformed small area BSA”) is transformed into an image of a rectangular small area having vertexes of division points Da′, Db, Dc, and Dd (“an after-transformed small area ASA”).

In this embodiment, after the rectangular small area is divided into four triangular areas using a central point CG, each of the triangular areas is subjected to the image transforming process. In FIG. 22, the before-transformed small area BSA is divided into four triangular areas that each have the central point CG of the before-transformed small area BSA as one vertex. Likewise, the after-transformed small area ASA is divided into four triangular areas that each have a central point CG′ of the after-transformed small area ASA as one vertex. Each of the triangular areas before and after the movement of the division point Da is subjected to the image transforming process. For example, an image of the triangular area having vertexes of the division points Da, Dd, and the central point CG in the before-transformed small area BSA is transformed into an image of the triangular area having vertexes of the division points Da′, Dd, and the central point CG′ in the after-transformed small area ASA.

FIG. 23 shows a concept of an image transforming method in the triangular areas. In FIG. 23, an image of a triangular area stu having vertexes of points s, t and u is transformed into an image of a triangular area s′t′u′ having vertexes of points s′, t′ and u′. The transformation of the image is performed by calculating where some pixels in the image of the triangular area s′t′u′ subjected to the image transforming process are located in the image of the triangular area stu not subjected to the image transforming process, and setting pixel values of the image not subjected to the image transforming process to pixel values of the image subjected to the image transforming process.

For example, in FIG. 23, a location of a pixel p′ in the image of the triangular area s′t′u′ subjected to the image transforming process corresponds to a location p in the image of the triangular area stu not subjected to the image transforming process. The location of the pixel p is calculated as follows. First, coefficients m1 and m2 that are used to express the location of the pixel p, as a sum of a vector s′t′ and a vector s′u′ are calculated with reference to EQUATION 1 described below.

### EQUATION 1

\vec{s′p′}=m1·\vec{s′t′}+m2·\vec{s′u′} (1)

Next, the location p is obtained by calculating the sum of a vector st and a vector su in the triangular area stu not subjected to the image transforming process using the calculated coefficients m1 and m2 with reference to EQUATION 2.

### EQUATION 2

\vec{sp}=m1·\vec{st}+m2·\vec{su} (2)

When the location p in the triangular area stu not subjected to the image transforming process accords with a central location of a pixel of the image not subjected to the image transforming process, a pixel value of the pixel becomes a pixel value of the image subjected to the image transforming process. Alternatively, when the location p in the triangular area stu not subjected to the image transforming process accords with the central location of the pixel of the image not subjected to the image transforming process, a pixel value in the location p is calculated by interpolation calculation such as bi-cubic interpolation using a pixel value of a pixel around the location p. The calculated pixel value becomes the pixel value of the image subjected to the image transforming process.

By calculating the pixel value of each pixel in the image of the triangular area s′t′u′ subjected to the image transforming process in the above-described manner, it is possible to transform the image of the triangular area stu into the image of the triangular area s′t′u′. The division area transforming portion 256 performs the image transforming process on the transformation area TA by defining the triangular areas in the above-described manner with respect to each of the small areas of the transformation area TA shown in FIG. 19 and performing the image transforming process on the triangular areas.

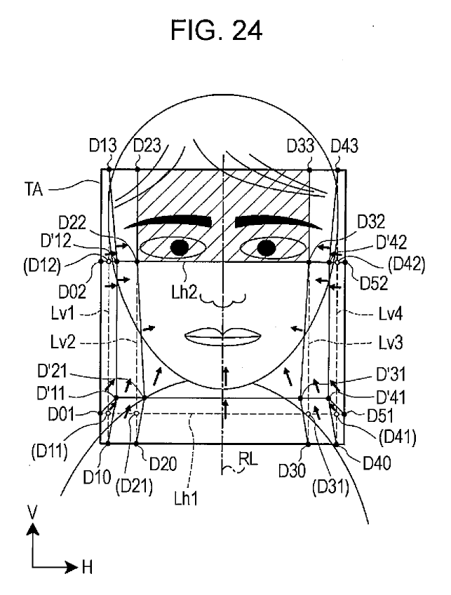

The facial contour correcting process of this embodiment is now described in detail. FIG. 24 shows the facial contour correcting process according to this embodiment. In FIG. 24, transformed images of the small areas constituting the transformation area TA are indicated by arrows. In the facial contour correcting process, as shown in FIG. 24, the locations of the division points D11, D21, D31, and D41 arranged on the horizontal division line Lh1 are moved upward in the V direction parallel to the reference line RL, but the division points D12, D22, D32, D42 arranged on the horizontal division line Lh2 are not moved (FIG. 20). Accordingly, the image between the horizontal division lines Lh1 and Lh2 is reduced in the V direction. As described above, the horizontal division line Lh1 is arranged below the chin image and the horizontal division line Lh2 is arranged immediately below the eyes image. Therefore, in the facial contour correcting process according to this embodiment, the facial image from the chin to the portion below the eyes is reduced in the V direction. As a result, a chin line of the image is moved upward.

Meanwhile, the division points D11 and D12 arranged on the vertical division line Lv1 are moved rightward in the H direction perpendicular to the reference line RL and the division points D41 and D42 arranged on the vertical division line Lv4 are moved leftward (FIG. 20). Moreover, the division point D21 arranged on the horizontal division line Lh1 of the two division points D arranged on the vertical division line Lv2 is moved rightward and the division point D31 arranged on the horizontal division line Lh1 of the two division points D arranged on the vertical division line Lv3 is moved leftward (FIG. 20). Accordingly, the image located on the left side of the vertical division line Lv1 is expanded rightward in the H direction and the image located on the right side of the vertical division line Lv4 is expanded leftward. The image located between the vertical division lines Lv1 and Lv2 is reduced in the H direction or moved rightward, and the image located between the vertical division lines Lv3 and Lv4 is reduced in the H direction or moved leftward. The image located between the vertical division lines Lv2 and Lv3 is reduced in the H direction with respect to the horizontal division line Lh1.

As described above, the vertical division lines Lv1 and Lv4 are arranged outside the image of cheek lines, and the vertical division lines Lv2 and Lv3 are arranged outside the image of eyes. Accordingly, in the facial contour correcting process according to this embodiment, the image outside the two eyes in the facial image is reduced in the H direction on the whole. In particular, the image of the chin is more reduced. As a result, the facial contour in the image becomes thin in the widthwise direction on the whole.

Consequently, the facial contour in the image is reduced in the H direction and V direction described above by performing the facial contour correcting process according to this embodiment.

A small area (indicated by hatching) having vertexes of the division points D22, D32, P33, and D23 shown in FIG. 24 becomes an area including two eyes by using the method of arranging the horizontal division line Lh2 or the vertical division lines Lv2 and Lv3 described above. As shown in FIG. 20, the division points D22 and D32 are not moved in either the H or the V direction. Accordingly, the small area including the two eyes is not transformed. According to this embodiment, the image subjected to the facial contour correcting process becomes a more preferable image by not performing the image transforming process on the small area including the two eyes.

### B. Modified Examples

The invention is not limited to the above-described embodiment, but may be modified in various forms without departing the gist of the invention. For example, the invention may be modified as follows.

### E1. Modified Example 1

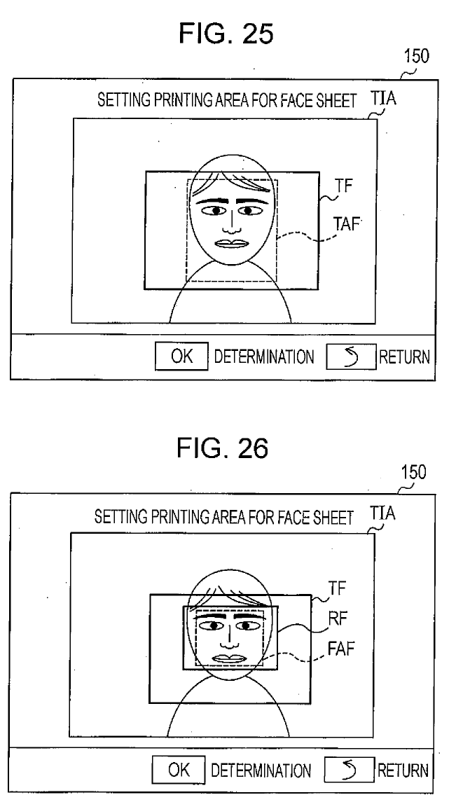

FIG. 25 illustrates an example of a user interface used to set the printing area for face sheet FS in Modified Example 1. A difference from the example of FIG. 10 is that the reference frame RF is not shown in the display image DI and a transformation area frame TAF showing an area corresponding to the transformation area TA is displayed instead in Modified Example 1. In Modified Example 1, since the transformation area frame TAF is displayed in the display image DI, a user can set the printing area for the face sheet FS, which is set as the area of the target image TI corresponding to the trimming frame TF, as an area including the transformation area TA, by designating the trimming frame TF to include the transformation area frame TAF. Therefore, the face sheet image FI corresponding to the printing area for the face sheet FS includes an image area required to perform the face reduction correcting process. Accordingly, in Modified Example 1, it is also possible to designate the image area without difficulty in transforming the facial image.

In Modified Example 1, the area corresponding to the transformation area TA corresponds to a second area in the invention. Like the modified example shown in FIG. 25, the transformation area frame TAF may be displayed on the display image DI instead of the reference frame RF even in the user interface (FIG. 16) used to set the printing area.

### B2. Modified Example 2

FIG. 26 illustrates an example of a user interface used to set the printing area for face sheet FS in Modified Example 2. A difference from the embodiment of FIG. 10 is that a facial area frame FAF showing an area corresponding to the facial area FA is also displayed on the display image DI in Modified Example 2. In Modified Example 2, the relationship between the reference frame RF and the trimming frame TF is different from that in the above-described embodiment. That is, when the reference frame RF is set to include the facial area frame FAF therein, the relationship between the reference frame RF and the trimming frame TF is set so that the trimming frame TF includes an area in the display image DI corresponding to the transformation area TA therein. Therefore, it is possible to set the printing area for the face sheet FS set as the area in the target image TI corresponding to the trimming frame TF in such a manner that the user designates the trimming frame TF with reference to the reference frame RF so that the reference frame RF includes the facial area frame RAF. In this way, the face sheet image FI corresponding to the printing area for the face sheet FS becomes an image including the image area required to perform the face reduction correcting process. Accordingly, in Modified Example 2, it is also possible to designate the image area without difficulty in correcting the facial image.

In Modified Example 2, the area corresponding to the facial area FA corresponds to a fourth area in the invention and the area defined by the reference frame RF corresponds to a fifth area in the invention. In addition, in the user interface (FIG. 16) used to set the printing area, the facial area frame FAF may also be displayed in the display image DI, like Modified Example of FIG. 26.

### B3. Modified Example 3

In the above-described embodiments, the image correcting processes (the face reduction and skin clarifying correcting processes) of an image and the printing process performed after the correcting processes have been described. However, the invention may be applied to a process of transforming an image corresponding to an area designated in the display image in an image of a specific kind of photographic subject. For example, the invention may be applied to the face reduction correcting process executed on a personal computer or a correcting process of transforming a subject (buildings, etc.) other than a face.

### B4. Modified Example 4

In the above-described embodiments, the reference frame RF has been displayed in the display image DI in both the user interface (FIG. 10) used to set the printing area for the face sheet FS and the user interface (FIG. 16) used to set the printing area. However, the reference frame RF may be displayed only in one of the user interfaces.

### B5. Modified Example 5

In the above-described embodiments, the methods of setting the facial area FA and the transformation area TA are just examples, and other methods of setting these areas may be used. For example, the facial area FA is not necessarily set by detecting the area including the facial image through image analysis of the target image TI, but the facial area FA may be set on the basis of designation of its location by the user. In addition, the transformation area TA may be set as an area different from that in the above-described embodiment as long as the transformation area TA has a predetermined relationship with the facial image in terms of a location and a size. In addition, the facial area FA and the transformation area TA may not be rectangular, but may be polygonal or circular.

### B6. Modified Example 6

The methods of performing the image transforming process in the above-described embodiment are just examples. Such a process may be performed by other methods.

### B7. Modified Example 7

In the above-described embodiments, the printer 100 as the image processing device performs the printing process (FIG. 2), but a part of the printing process may be executed on a personal computer. In addition, the printer 100 is not limited to an inkjet printer, but may be another printer such as a laser printer or a sublimation printer.

### B8. Modified Example 8

In the above-described embodiments, a part of the configuration embodied in the form of hardware may be substituted by software. Conversely, a part of the configuration embodied in the form of software may be substituted by hardware.

When a part or all of the functions according to the invention is realized in the form of software, the software (computer program) is provided in a form stored in a recording medium readable by computers. In the invention, a recording medium readable by computers is not limited to portable recording mediums such as a flexible disc or a CD-ROM, but may be inner storage devices of computers, such as various RAMs or ROMs or external storage devices fixed to computers, such as hard discs.

What is claimed is:

1. An image processing device comprising:
an image display unit that displays an image;
an area designation receiving unit that receives designation of a first area in a display image by a user;
a transformation processing unit that transforms an image corresponding to the first area in a predetermined transformation area in order to transform an image of a specific kind of photographic subject; and
a reference display unit that shows a predetermined reference display in the display image in order to allow the user to designate an area, which includes a second area corresponding to the transformation area in the display image, as the first area.

2. The image processing device according to claim 1,
wherein the reference display includes a display showing a third area having a relationship with the first area that is set in advance so that the first area includes the second area, when the third area is set to include the image of the specific kind of photographic subject.

3. The image processing device according to claim 1, wherein the reference display includes a display showing the second area.

4. The image processing device according to claim 1, further comprising:
a photographic subject area setting unit that sets an area of the image of the specific kind of photographic subject in an image,
wherein the reference display includes a display showing a fourth area corresponding to the set area of the image of the specific kind of photographic subject and a display showing a fifth area having a relationship with the first area that is set in advance so that the first area includes the second area, when the fifth area is set so as to include the fourth area.

5. The image processing device according to claim 1, wherein the transformation area has a predetermined relationship with the image of the specific kind of photographic subject in terms of location and size.

6. The image processing device according to claim 1, wherein the specific kind of photographic subjects is a face of a person.

7. An image processing method comprising:
displaying an image;
receiving designation of a first area in a display image by a user;
transforming an image corresponding to the first area in a predetermined transformation area in order to transform an image of a specific kind of photographic subject; and
showing a predetermined reference display in the display image in order to allow the user to designate an area, which includes a second area corresponding to the transformation area in the display image, as the first area.

8. A computer program stored in a recording medium readable by a computer for causing the computer to execute image processing comprising:
an image display function that displays an image;
an area designation receiving function that receives designation of a first area in a display image by a user;
a transformation processing function that transforms an image corresponding to the first area in a predetermined transformation area in order to transform an image of a specific kind of photographic subject; and
a reference display function that shows a predetermined reference display in the display image in order to allow the user to designate an area, which includes a second area corresponding to the transformation area in the display image, as the first area.
